(19) United States
(12) Patent Application Publication
(10) Pub. No.: US 2026/0264771 A1
(43) Pub. Date: Sep. 10, 2026

(54) VEHICLE TAILGATE WITH SELF-DRAINING SENSOR RECESS

(71) Applicant: Robert Bosch GmbH, Stuttgart (DE)

(72) Inventor: Jeffrey Reuter, Farmington, MI (US)

(21) Appl. No.: 19/074,019

(22) Filed: Mar. 7, 2025

(51) Int. Cl. B62D 33/027

(52) U.S. Cl. CPC B62D 33/0273

(57) ABSTRACT

A vehicle including a vehicle body having a cabin area and a cargo area including a vehicle bed assembly that defines a bed plane. The vehicle includes a sensor configured to provide data on the surroundings of the vehicle and a tailgate assembly that is pivotally connected to the vehicle bed assembly. The tailgate assembly is moveable between a raised configuration and a lowered configuration. The tailgate assembly includes an outer wall that is perpendicular to the bed plane in the raised configuration and a top edge being parallel to the bed plane in the raised configuration. The top edge includes a receptacle configured to receive the sensor, a recess that surrounds the receptacle, and a drain in fluid communication with the receptacle.

### BACKGROUND

The present disclosure relates to improvements to the integration of sensors into a vehicle tailgate.

### SUMMARY

The present disclosure provides, in one aspect, a vehicle including a vehicle body having a cabin area and a cargo area including a vehicle bed assembly that defines a bed plane. The vehicle includes a sensor configured to provide data on the surroundings of the vehicle and a tailgate assembly that is pivotally connected to the vehicle bed assembly. The tailgate assembly is moveable between a raised configuration and a lowered configuration. The tailgate assembly includes an outer wall that is perpendicular to the bed plane in the raised configuration and a top edge being parallel to the bed plane in the raised configuration. The top edge includes a receptacle configured to receive the sensor, a recess that surrounds the receptacle, and a drain in fluid communication with the receptacle.

The present disclosure provides, in another aspect, a vehicle tailgate assembly moveable between a raised configuration and a lowered configuration, the vehicle tailgate assembly includes a main body having a proximal end and a distal end opposite the proximal end. The distal end is oriented upwardly when the vehicle tailgate assembly is in the raised configuration. The vehicle tailgate assembly includes a cap coupled to the main body at the distal end. The cap includes a receptacle configured to receive a sensor, a recess surrounding the receptacle, and a drain in fluid communication with the recess.

### BRIEF DESCRIPTION OF THE DRAWINGS

FIG. 1 is a perspective view of a prior art vehicle having a tailgate assembly in a raised configuration.

FIG. 2 is a perspective view of the vehicle of FIG. 1 having the tailgate assembly in a lowered configuration.

FIG. 3 is a top view of a known top edge of the tailgate assembly of FIG. 1.

FIG. 4 is a perspective view of a top edge compatible with the tailgate assembly of FIG. 1, according to a construction of the disclosure.

FIG. 5 is a side view of the top edge of FIG. 4.

FIG. 6 is a perspective view of a recess of the top edge of FIG. 4 taken about lines 6-6.

FIG. 7 is a top view of the recess of FIG. 6.

FIG. 8 is a cross-sectional view of the recess of FIG. 7 taken along lines 8-8.

FIG. 9 is a perspective view of another recess of the top edge of FIG. 4 taken about lines 9-9.

FIG. 10 is a top view of the recess of FIG. 9.

FIG. 11 is a perspective view of another top edge compatible with the tailgate assembly of FIG. 1, according to a construction of the disclosure.

FIG. 12 is a side view of the top edge of FIG. 11.

FIG. 13 is a perspective view of another top edge compatible with the tailgate assembly of FIG. 1, according to a construction of the disclosure.

FIG. 14 is a side view of the top edge of FIG. 13.

Before any constructions of the disclosure are explained in detail, it is to be understood that the disclosure is not limited in its application to the details of construction and the arrangement of components set forth in the following description or illustrated in the following drawings. The disclosure is capable of other constructions and of being practiced or of being carried out in various ways.

### DETAILED DESCRIPTION

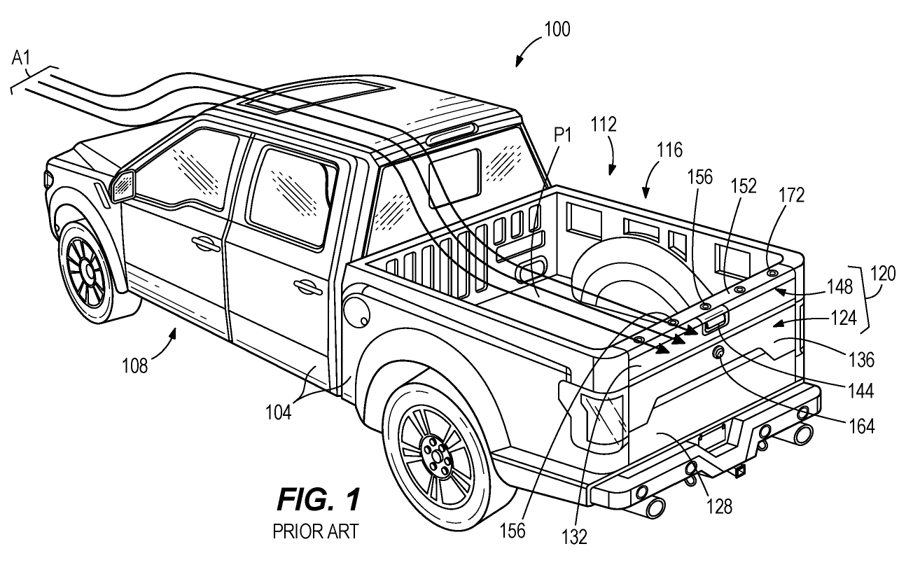

FIGS. 1-3 illustrate a prior art vehicle 100. Specifically, the vehicle 100 includes a vehicle body 104, a cabin area 108, and a cargo area 112 having a vehicle bed assembly 116. The vehicle bed assembly 116 defines a bed plane P1. The vehicle 100 defines a tailgate assembly 120 that is pivotably connected to the vehicle bed assembly 116. The tailgate assembly 120 includes a main body 124 having a proximal end 128 pivotally connected to the vehicle 100 via the vehicle bed assembly 116 and a distal end 132 opposite the proximal end 128. The main body 124 includes an outer wall 136, an inner wall 140 opposite the outer wall 136, and a handle assembly 144 supported by the outer wall 136. The inner wall 140 faces toward the cargo area 112 and the vehicle bed assembly 116. The outer wall 136 faces away from the cargo area 112 and the vehicle bed assembly 116. The handle assembly 144 is configured to lock a position of the tailgate assembly 120 relative to the vehicle bed assembly 116 (e.g., the bed plane P1).

The tailgate assembly 120 includes a cap 148 coupled to the distal end 132 of the main body 124 that defines a top edge 152 of the tailgate assembly 120. The top edge 152 is disposed between the outer wall 136 and the inner wall 140. The top edge 152 is perpendicular to the outer wall 136 and the inner wall 140. In the illustrated construction, the cap 148 is formed separately from the main body 124 and is coupled to the main body 124. Specifically, the cap 148 is formed from a polymer. In other constructions, the cap 148 is integrated with the main body 124. That is, the main body 124 and the cap 148 are made from a single piece.

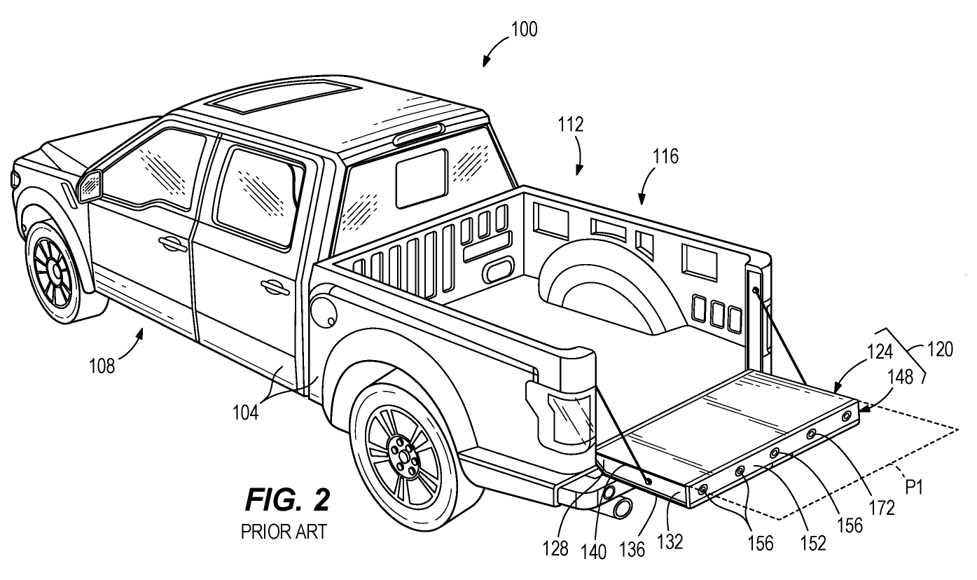

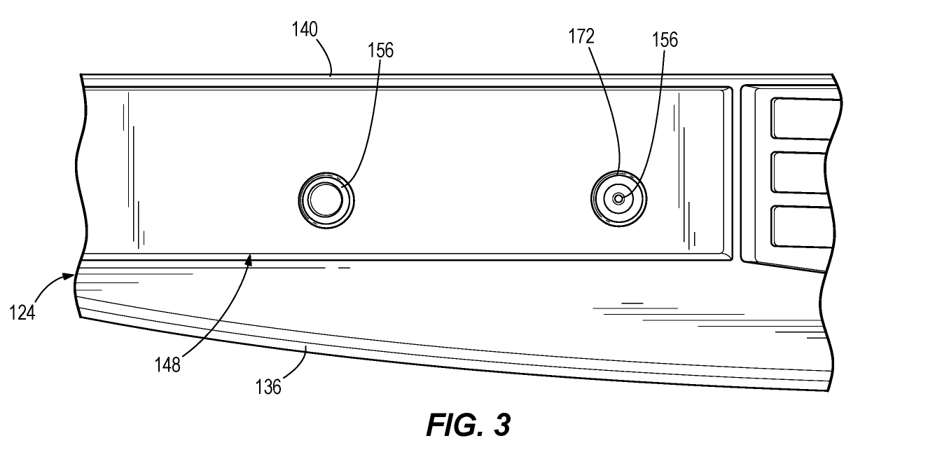

The vehicle 100 further includes a sensor 156 (e.g., a camera, an ultrasonic sensor, a radar sensor, an electromagnetic sensor) that is received by the top edge 152 of the cap 148 (FIG. 3). In the illustrated construction, the sensor 156 is a camera. As shown in FIGS. 1 and 2, the sensor 156 is a sensor of a plurality of sensors that are received by the top edge 152. The vehicle 100 includes a sensor 164 (e.g., a camera, an ultrasonic sensor, a radar sensor, an electromagnetic sensor) that is received by the outer wall 136. The sensors 156, 164 provide data (e.g., images, relative proximity) on the surroundings of the vehicle 100.

The tailgate assembly 120 is moveable between a raised configuration (i.e., FIG. 1) and a lowered configuration (i.e., FIG. 2). In the raised configuration, the outer wall 136 and the inner wall 140 are perpendicular to the bed plane P1. In the raised configuration, the distal end 132 is oriented upwardly. In the raised configuration, the top edge 152 is parallel to the bed plane P1. In the lowered configuration, the outer wall 136 and the inner wall 140 are parallel to the bed plane P1. In the lowered configuration, the distal end 132 is oriented rearwardly. In the lowered configuration, the top edge 152 is perpendicular to the bed plane P1.

In some constructions, the sensors 156, 164 may be selectively used based on the raised or lowered configuration of the tailgate assembly 120. For instance, in the raised position, the sensor 164 is used since the sensor 156 is facing in a direction generally perpendicular to the bed plane P1. In a lowered position, the sensor 156 is used since the sensor 164 is facing in a direction that is generally perpendicular to the bed plane P1.

FIG. 3 illustrates the cap 148 receiving the sensor 156. Specifically, the sensor 156 is disposed in a sensor pocket or recess 172 of the cap 148. The recess 172 is offset from the top edge 152 to protect the sensor 156 from damage or wear from normal use. As shown in FIG. 3, the recess 172 is a circular shape that surrounds the sensor 156. The recess 172 is prone to collecting debris and fluid (e.g., water, dirt, dust, snow, etc.) when the tailgate assembly 120 is in the raised configuration because there is no exit point for the debris and fluid. In other words, the recess 172 causes a bucket effect of collecting debris and fluid. For instance, in the case of rainfall, water accumulates in the recess 172 in the raised configuration. When moved from the raised configuration to the lowered configuration, the debris and fluid may adhere to the recess 172 and impair or prevent the proper operation of the sensor 156.

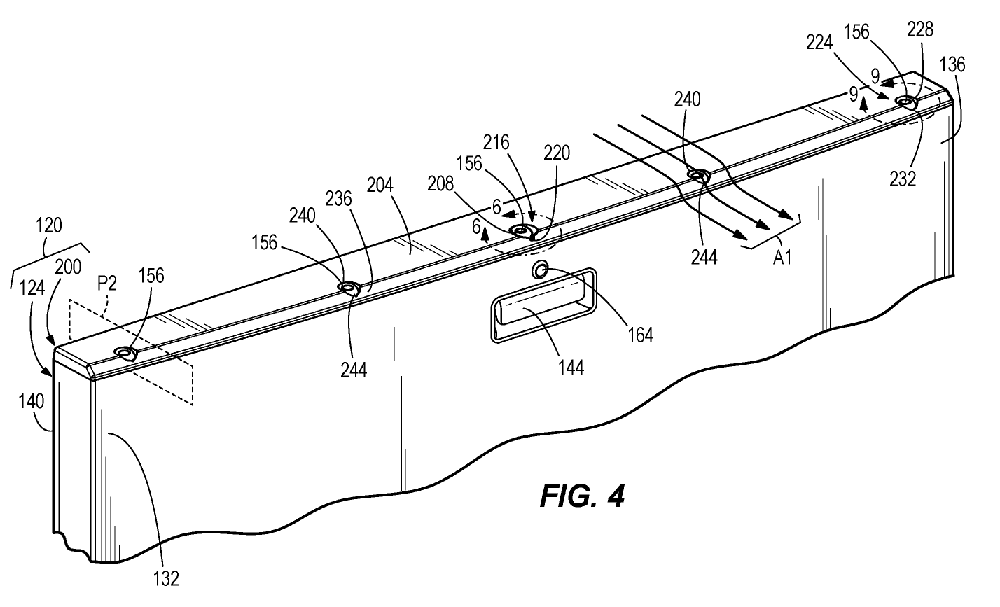

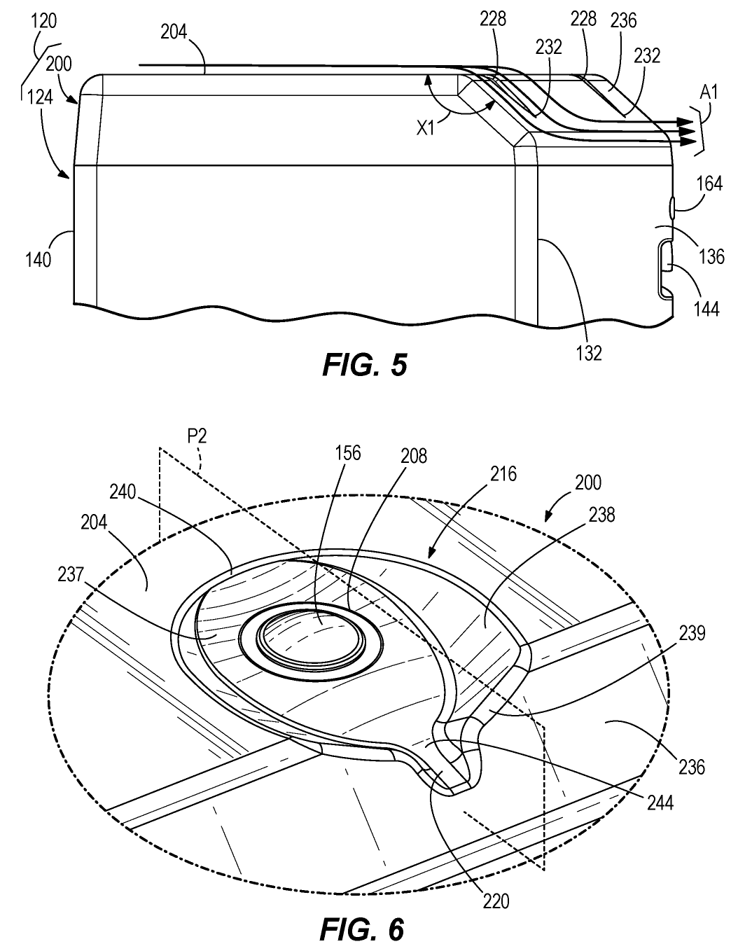

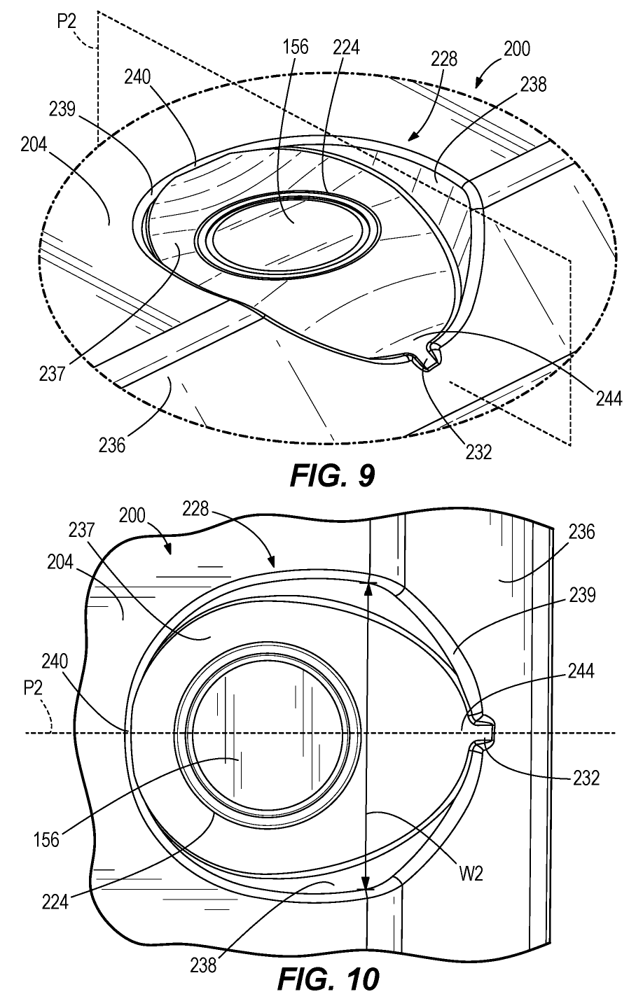

FIGS. 4 and 5 illustrate a cap 200 according to a construction of the present disclosure. The cap 200 is interchangeable with the cap 148, or otherwise similar for use with a tailgate such as that of the vehicle 100. The cap 200 is manufactured separately and attached to the main body 124. Specifically, the cap 200 is coupled to the distal end 132. In other constructions, the cap 200 is integrated into the main body 124 of the tailgate assembly 120 (e.g., the main body 124 and the cap 200 are a single piece). The cap 200 defines a top edge 204 having a receptacle 208 configured to receive the sensors 156. In the raised configuration, the top edge 204 is parallel to the bed plane P1. In the lowered configuration, the top edge 204 is perpendicular to the bed plane P1. The receptacle 208 is configured to receive the sensor 156. The top edge 204 includes a recess 216 that surrounds the receptacle 208. The top edge 204 includes a drain 220 in fluid communication with the recess 216. The receptacle 208, the recess 216, and the drain 220 are provided at a first (e.g., central) location along the width of the tailgate assembly 120. At one or more other (e.g., outboard) locations, the cap 200 includes another receptacle 224, recess 228, and drain 232 having an alternate geometry which is described in greater detail with respect to FIGS. 9 and 10. The recess 216 does not tend to hold debris and fluid since the drain 220 is configured to guide fluid and debris out of the recess 216. The cap 200 includes a slanted wall 236 that is angled from the top edge 204 at a non-zero angle X1 toward the outer wall 136. In some constructions, the angle X1 is between 100 degrees and 167 degrees (e.g., approximately 137 degrees). As shown in FIG. 4, the recess 216 extends between the top edge 204 and the slanted wall 236. In the illustrated construction, the drain 220 is defined on the slanted wall 236. Specifically, the drain 220 is defined in a middle section of the slanted wall 236. In the illustrated construction, the drain 220 is a slit.

FIGS. 6-8 illustrate the receptacle 208, the recess 216, and the drain 220 in greater detail. As shown in FIG. 6, the recess 216 is configured to direct fluid away from the sensor 156 and toward the drain 220. In other words, the recess 216 includes curved surfaces that each contribute to the draining effect on debris and fluid in the recess 216. Specifically, the recess 216 includes a bottom wall 237 and a sidewall 238 extending from the bottom wall 237. The sidewall 238 extends between the bottom wall 237 and the top edge 204. The recess includes a boundary edge 239 that is disposed between the sidewall 238 and the top edge 204 or the slanted wall 236. The recess 216 includes a first end 240 and a second end 244 opposite the first end 240. The first end 240 is nearer to the cargo area 112 than the second end 244. That is, the first end 240 is nearer to the inner wall 140 than the second end 244. As shown near the first end 240, the sidewall 238 is reduced or non-existent. As such, the boundary edge 239 is adjacent to the bottom wall 237. As shown near the second end 244, the sidewall 238 is reduced or non-existent and the boundary edge 239 is adjacent the bottom wall 237. In some constructions, the boundary edge 239 at the second end 244 can be flush with the bottom wall 237 such that the boundary edge 239 at the second end 244 forms a drain for the recess 216. In other words, the drain 220 is not constrained to the geometry of a slit, as shown. Rather, the drain 220 can be constructed in a variety of ways that provide a path for freely guiding fluid and debris out of the recess 216.

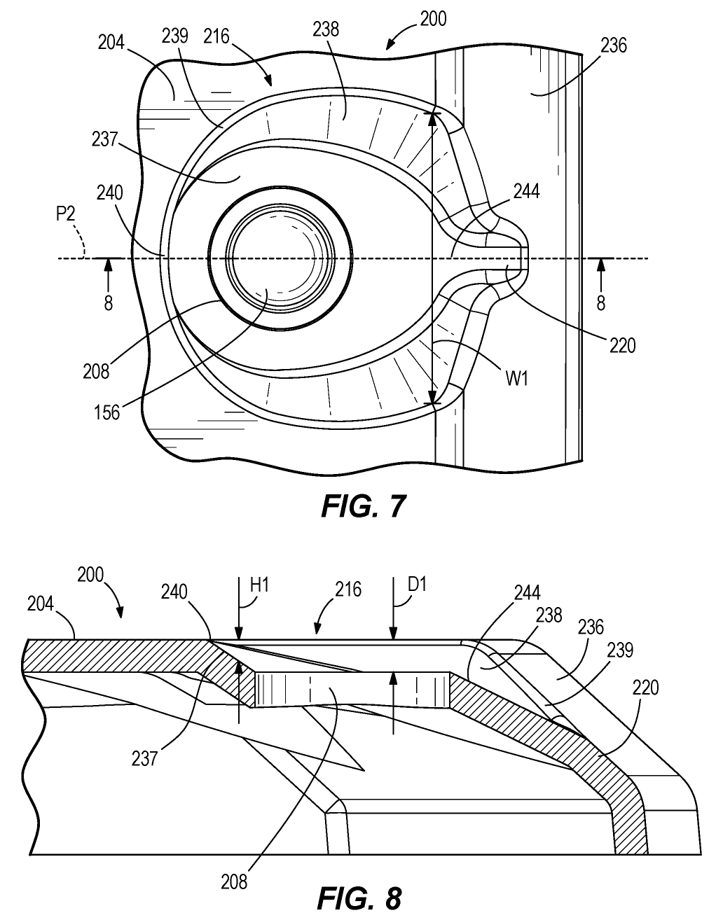

Referring to FIG. 7, the receptacle 208, the recess 216, and the drain 220 define a plane P2. In the illustrated construction, the plane P2 bisects the receptacle 208 and the recess 216, and the drain 220. Specifically, the plane P2 extends through the first end 240 and the second end 244 of the recess 216 in a longitudinal and vertical direction. In other words, the plane P2 is perpendicular to the plane P1 and the main body 124. The recess 216 defines a width W1 that is measured perpendicular to the plane P2 and at a point between the top edge 204 and the slanted wall 236. In some constructions, the width W1 is between 10 millimeters and 60 millimeters (e.g., approximately 35 millimeters). In the illustrated construction, the recess 216 is symmetrical about the plane P2.

FIG. 8 illustrates the receptacle 208 with the sensor 156 removed. The receptacle 208 is offset from the top edge 204 by a distance D1. The distance D1 is measured from the top edge 204 to the receptacle 208. In the illustrated construction, the distance D1 is approximately 3 millimeters. In other constructions, the distance D1 is at least 3 millimeters. In some constrictions, the distance D1 is between 0.5 millimeters and 10 millimeters. The receptacle 208 being offset from the top edge 204 permits the sensor 156 to be separated from the top edge, thereby decreasing potential contact. The recess 216 defines a sidewall height H1 that is measured from the top edge 204 to the bottom wall 237. In the illustrated construction, the sidewall height H1 at the first end 240 is approximately zero. The sidewall height H1 increases from the first end 240 to the second end 244. In other words, the sidewall height H1 measured nearer to the first end 240 than the second end 244 is smaller than the sidewall height H1 measured nearer to the second end 244 than the first end 240.

FIGS. 9 and 10 illustrate the receptacle 224, the recess 228, and the drain 232 in further detail. The recess 228 defines a width W2 that is measured perpendicular to the plane P2 and at a point between the top edge 204 and the slanted wall 236. The width W2 is approximately 30 millimeters. In the illustrated construction, the width W2 is less than the width W1 because the sensor 156 illustrated in FIGS. 9 and 10 is an electromagnetic sensor and the sensor in FIGS. 6 and 7 is a camera. The camera utilizes the greater width W1 than the width W2 utilized for the electromagnetic sensor because the camera benefits from a wider clearance than the electromagnetic sensor.

Referring back to FIG. 4, the recesses 216, 228 and the drains 220, 232 are configured to direct debris and fluid away from the sensors 156 because the recesses 216, 228 and the drains 220, 232 slope downwards when the tailgate assembly 120 is in the raised configuration. Specifically, the recesses 216, 228 and the drains 220, 232 direct the debris and fluid toward the outer wall 136 naturally due to gravity. As such, the recesses 216, 228 may already be clear at the time that the tailgate is lowered, and need not rely on the lowering of the tailgate (or other intentional acts by the user) to clear debris and/or fluid.

Referring back to FIG. 1, as the vehicle 100 moves forward, air passes over the vehicle 100 to form an airflow A1. As illustrated in FIG. 1, the airflow A1 passes over the tailgate assembly 120 in a direction perpendicular to the tailgate assembly 120 (e.g., the main body 124). However, the bucket effect caused by the recess 172 prevents the airflow A1 from moving through the recess 172. Moving back to FIG. 4, the recesses 216, 228 and the drains 220, 232 are formed to be perpendicular to the main body 124 of the tailgate assembly 120. In other words, the recesses 216, 228 and drains 220, 232 are parallel or aligned with the airflow A1. For instance, the plane P2 defined by each recess of the recesses 216, 228 is parallel to the airflow A1, thereby permitting the airflow flowing through the recesses 216, 228 and the drains 220, 232. The airflow A1 being able to flow through the recesses 216, 228 further increases the likelihood of debris and fluid being expelled around the sensors. Additionally, the minimal sidewall height H1 closer to the first end 240 helps the airflow A1 enter the recesses 216, 228. The first end 240 can be considered a leading end and the second end 244 can be considered a trailing end when the tailgate assembly 120 is in the raised position because the first end 240 is a leading point of contact for the recesses 216, 228 engaging the airflow A1. The second end 244 can be considered a trailing end when the tailgate assembly 120 is in the raised position because the second end 240 is the last point of contact for the recess 216, 228 engaging the airflow A1.

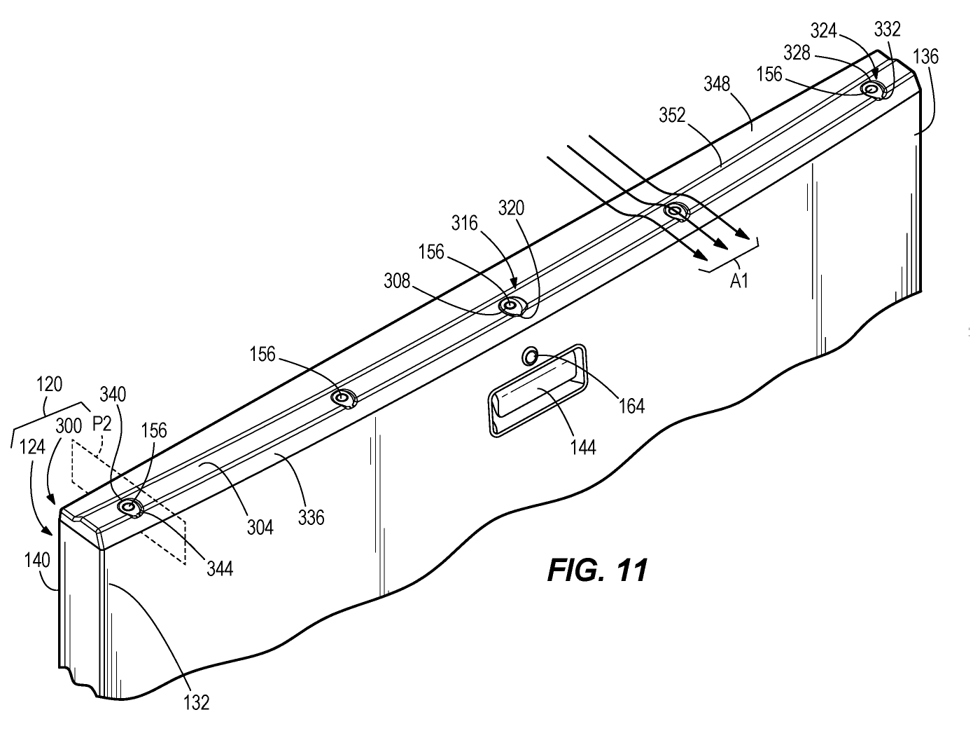

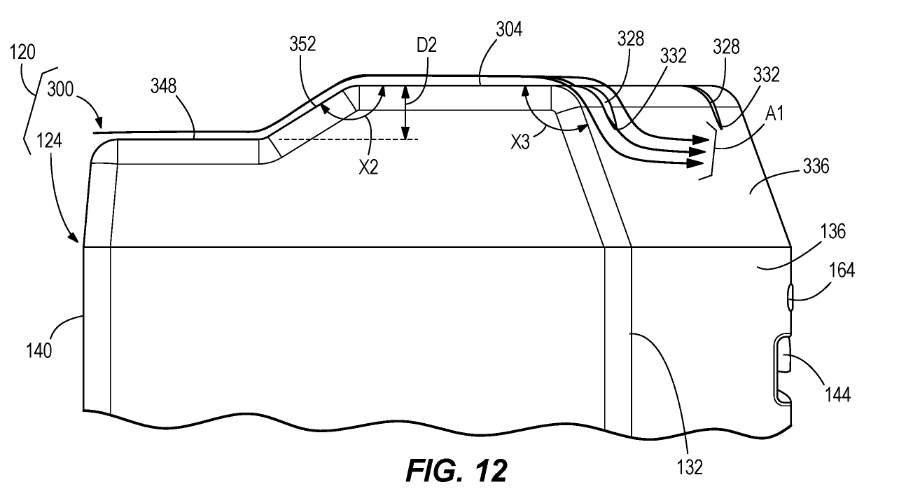

FIGS. 11 and 12 illustrates a cap 300 according to another construction of the disclosure. Many features of the cap 300 are similar to those discussed above with regard to the first construction of the cap 200. As such, reference is made to the preceding disclosure as opposed to discussing these features again below. Features similar to the those discussed above are labeled with a reference number that is a value of one hundred higher than the corresponding feature described with respect to the cap 200.

The cap 300 defines the top edge 304 and a lower top edge 348. The top edge 304 and the lower top edge 348 are parallel. The lower top edge 348 is nearer to the main body 124 of the tailgate assembly 120 than the top edge 304. The lower top edge 348 is nearer to the inner wall 140 than the top edge 304. The lower top edge 348 is offset from the top edge 304 by a distance of D2. In some constructions, the distance D2 is between 5 millimeters and 20 millimeters (e.g., approximately 10 millimeters). The cap 300 includes a slanted wall 352 that connects the lower top edge 348 to the top edge 304. The slanted wall 352 is offset from the lower top edge 348 by a non-zero angle X2. In some constructions, the angle X2 is between 118 degrees and 178 degrees (e.g., approximately 148 degrees). The lower top edge 348 and the slanted wall 352 induce a different path for the airflow path A1 as shown in FIGS. 11 and 12. Specifically, the airflow A1 flows across the lower top edge 348 and across the slanted wall 352. The slanted wall 352 raises the airflow A1 such that the airflow A1 moves across the top edge 304 and into the recesses 320, 328. From the top edge 304 or the recesses 320, 328, the airflow flows across the slanted wall 336. The slanted wall 336 is angled from the top edge 304 at a non-zero angle X3. In some constructions, the angle X3 is between 79 degrees and 139 degrees (e.g., approximately 109 degrees).

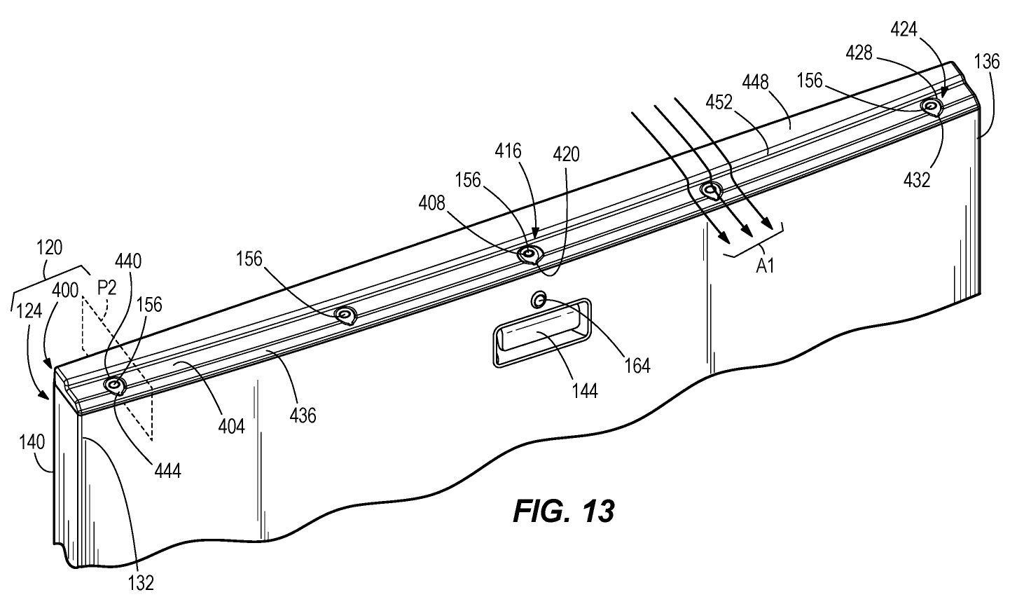

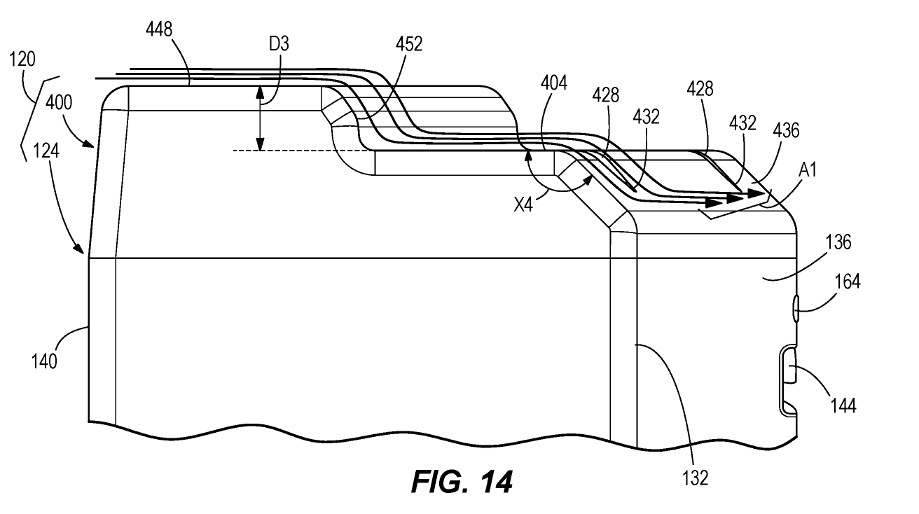

FIGS. 13 and 14 illustrates a cap 400 according to another construction of the disclosure. Many features of the cap 400 are similar to those discussed above with regard to the first construction of the cap 200. As such, many of these features will not be discussed again below. Features similar to the those discussed above will be labeled with a reference number that is a value of two hundred higher than the corresponding feature described with respect to the cap 200.

The cap 400 defines the top edge 404 and an upper top edge 448. The top edge 404 and the upper top edge 448 are parallel. The top edge 404 is nearer to the main body 124 of the tailgate assembly 120 than the upper top edge 448. The upper top edge 448 is nearer to the inner wall 140 than the top edge 404. The upper top edge 448 is offset from the top edge 404 by a distance of D3. In some constructions, the distance D3 is between 1 millimeter and 15 millimeters (e.g., approximately 12 millimeters). The cap 300 includes a curved wall 452 that connects the upper top edge 448 to the top edge 404. The upper top edge 448 and the curved wall 452 induce a different path for the airflow path A1 as shown in FIGS. 12 and 13. Specifically, the airflow A1 flows across the upper top edge 448 and across the curved wall 452. The curved wall 452 lowers the airflow A1 such that the airflow A1 flows across the top edge 404 and into the recesses 420, 428. From the top edge 404 or the recesses 420, 428, the airflow flows across the slanted wall 436. The slanted wall 436 is angled from the top edge 404 at a non-zero angle X4. In some constructions, the angle X4 is between 105 degrees and 165 degrees (e.g., approximately 135 degrees).

Although the disclosure has been described in detail with reference to certain preferred constructions, variations and modifications exist within the scope and spirit of one or more independent aspects of the disclosure as described.

What is claimed is:

1. A vehicle comprising:
a vehicle body having a cabin area and a cargo area including a vehicle bed assembly, the vehicle bed assembly defining a bed plane;
a sensor configured to provide data on surroundings of the vehicle; and
a tailgate assembly that is pivotally connected to the vehicle bed assembly, the tailgate assembly being moveable between a raised configuration and a lowered configuration, the tailgate assembly including
an outer wall that is perpendicular to the bed plane in the raised configuration, and
a top edge being parallel to the bed plane in the raised configuration, the top edge including a receptacle configured to receive the sensor, a recess that surrounds the receptacle, and a drain in fluid communication with the receptacle.

2. The vehicle of claim 1, wherein the sensor is a first sensor, the vehicle further comprising a second sensor, and wherein the outer wall is configured to receive the second sensor.

3. The vehicle of claim 1, wherein the outer wall faces away from the cargo area, and wherein the drain is configured to direct water toward the outer wall.

4. The vehicle of claim 1, wherein the drain is formed by a slit configured to guide water out of the recess.

5. The vehicle of claim 1, wherein the recess includes a bottom wall and sidewall extending between the bottom wall and the top edge.

6. The vehicle of claim 1, wherein the receptacle is recessed from the top edge by at least 3 millimeters.

7. The vehicle of claim 1, wherein the recess includes a first end and a second end configured to permit an airflow to pass through the first and second end in the raised configuration such that water is directed toward the drain.

8. The vehicle of claim 1, wherein the tailgate assembly includes
a main body having a proximal end pivotally coupled to the vehicle bed assembly and a distal end opposite the proximal end, and
a cap coupled the main body at the distal end, the cap defining the top edge.

9. The vehicle of claim 8, wherein the recess has a first end and a second end opposite the first end, wherein the first end is nearer to the cargo area than the second end, wherein the recess and the drain define a plane, wherein the plane bisects the recess and the drain, wherein the plane extends through the first end and the second end of the recess, and wherein the plane is perpendicular to the main body of the tailgate assembly.

10. The vehicle of claim 1, wherein the recess has a first end and a second end opposite the first end, wherein the first end is nearer to the cargo area than the second end, wherein the recess defines a sidewall height, and wherein the sidewall height is greater closer to the second end than to the first end.

11. A vehicle tailgate assembly moveable between a raised configuration and a lowered configuration, the vehicle tailgate assembly comprising:
a main body having a proximal end and a distal end opposite the proximal end, wherein the distal end is oriented upwardly when the vehicle tailgate assembly is in the raised configuration; and
a cap coupled to the main body at the distal end, the cap including
a receptacle configured to receive a sensor,
a recess surrounding the receptacle, and
a drain in fluid communication with the recess.

12. The vehicle tailgate assembly of claim 11, wherein the main body includes
a handle configured to lock the main body relative to the raised configuration and lowered configuration,
an inner wall, and
an outer wall opposite the inner wall and configured to support the handle.

13. The vehicle tailgate assembly of claim 12, wherein the cap defines a top edge and a slanted wall connected to the top edge, wherein the slanted wall is angled toward the outer wall, and wherein the recess extends between the top edge and the slanted wall.

14. The vehicle tailgate assembly of claim 13, wherein the drain is defined on the slanted wall.

15. The vehicle tailgate assembly of claim 13, wherein the cap defines a lower top edge, wherein the top edge and the lower top edge are parallel, and wherein the lower top edge is nearer to the main body than the top edge.

16. The vehicle tailgate assembly of claim 13, wherein the cap defines an upper top edge, wherein the top edge and the upper top edge are parallel, and wherein the top edge is nearer to the main body than the upper top edge, and wherein the top edge is nearer to the outer wall than the upper top edge.

17. The vehicle tailgate assembly of claim 16, wherein the upper top edge is offset from the top edge by a distance less than 12 millimeters.

18. The vehicle tailgate assembly of claim 11, wherein the cap defines a top edge, and wherein the receptacle is offset from the top edge by at least 3 millimeters.
